(19) United States
(12) Patent Application Publication
(10) Pub. No.: US 2025/0235374 A1
(43) Pub. Date: Jul. 24, 2025

(54) ADULT TOY SUPPORT

(71) Applicant: Intora, Inc. d/b/a Sportsheets International, Inc., Cerritos, CA (US)

(72) Inventors: Julie A. Stewart, Huntington Beach, CA (US); Sandy Rausch, Long Beach, CA (US); Emily Kay Silva, Costa Mesa, CA (US); Kelly Sofferman, Long Beach, CA (US)

(21) Appl. No.: 18/421,346

(22) Filed: Jan. 24, 2024

(51) Int. Cl. A61H 19/00

(52) U.S. Cl. CPC A61H 19/44; A61H 2201/0119; A61H 2201/1685

(57) ABSTRACT

A support for an adult toy includes a body with an upper surface and a lower surface. The body defines an opening extending between the upper surface and the lower surface. The opening is dimensioned to receive an adult toy therethrough. The support is configured to be removably attached to a support structure to secure the adult toy to the support structure.

### TECHNICAL FIELD

Embodiments of the present disclosure generally relate to accessories for adult toys, and, more specifically, a support for adult toys.

### BACKGROUND

Physical intimacy is one of the most important components of a healthy and long-term romantic relationship. Many people continually seek new ways of exploring their physical intimacy. For example, some people utilize adult toys (e.g., vibrators, objects mimicking sexual organs, etc.) to enhance their sensuality during foreplay or sexual intercourse. However, handling an adult toy while engaging in such sexual activities may be cumbersome and/or detract from the experience, for example, based on the need to manipulate the adult toy when engaging in various sexual positions (e.g., a rear penetrating position, a standing position, etc.). There exists a need for an accessory configured to support adult toys in a way that is convenient to the user while engaging in a variety of sexual activities.

### SUMMARY

The following presents a simplified summary of the disclosure in order to provide a basic understanding of some example aspects described in the detailed description. This summary is not an extensive overview. Moreover, this summary is not intended to identify critical elements of the disclosure nor delineate the scope of the disclosure. The sole purpose of the summary is to present some concepts in simplified form as a prelude to the more detailed description that is presented later.

In accordance with one aspect, there is provided a support for adult toys. The support includes a body with an upper surface and a lower surface. An opening extends between the upper surface and the lower surface and is dimensioned to receive an adult toy there-through. The support is configured to be removably attached to a support structure to secure the adult toy thereto.

In accordance with another aspect, there is provided an adult toy kit including a support and a positioner. The support includes a flexible body defining an opening extending between an upper surface and a lower surface thereof. The opening is dimensioned to receive an adult toy therethrough. The lower surface of the body includes a fastener thereon. The positioner includes an outer surface with a mating fastener disposed thereon configured to engage with the fastener of the support to removably attach and secure the support to the positioner.

In accordance with another aspect, there is provided a support including a body. The body includes a first layer and a second layer. The first and the second layer define a first channel therebetween extending in a direction substantially parallel to an upper surface of the first layer. The channel is configured to receive a portion of an adult toy therein.

The following description and the drawings disclose various illustrative aspects. Some improvements and novel aspects may be expressly identified, while others may be apparent from the description and drawings.

### BRIEF DESCRIPTION OF THE DRAWINGS

The present teachings may be better understood by reference to the following detailed description taken in connection with the following illustrations, in which like reference characters refer to like parts throughout, wherein:

FIG. 1A is a perspective view of an example support for adult toys according to an embodiment;

FIG. 1B is a section view taken along line 1B-1B of FIG. 1A;

FIG. 2A is a bottom view of the support of FIG. 1;

FIG. 2B is a bottom view of an example support according to another embodiment;

FIG. 3A is an exploded view of an example support according to another embodiment;

FIG. 3B is an exploded view of an example support according to another embodiment;

FIG. 4 is a perspective view of an example support according to another embodiment;

FIG. 5A is an exploded view of the support of FIG. 4;

FIG. 5B is an exploded view of an example support according to another embodiment;

FIG. 6 is a bottom view of the support of FIG. 5A;

FIGS. 7A-7B are perspective views of example positioners;

FIG. 8 is a perspective view of example adult toys shown in relation to an example support according to an embodiment;

FIG. 9A is a perspective view a support with an adult toy attached to an example positioner according to an embodiment;

FIG. 9B is a side view a penetrating person and a receiving person adjacent to an adult toy received by a support according to an embodiment;

FIG. 9C is a perspective view of an example support with an adult toy extending upward therefrom according to an embodiment;

FIG. 9D is a sectional view of the example support of FIG. 9C taken along line 9D-9D in FIG. 9C;

FIG. 10A is a perspective view of an example positioner bar according to an embodiment;

FIG. 10B is a perspective view of an example support attached to the positioner bar of FIG. 10A with an adult toy extending outward therefrom;

FIG. 11A is a perspective view of an example support shown in relation to an example adult toy according to an embodiment;

FIG. 11B is a perspective view of the support and adult toy of FIG. 11A with the adult toy received by the support;

FIG. 12 is a perspective view of an example support with an adult toy attached to a bed sheet according to an embodiment;

FIG. 13 is a perspective view of an example support with an adult toy attached to a wall according to an embodiment;

FIG. 14A is a perspective view of an example support according to another embodiment;

FIG. 14B is a section view taken along line 14B-14B of FIG. 14A.

### DETAILED DESCRIPTION

Reference will now be made in detail to exemplary embodiments of the present disclosure, examples of which are illustrated in the accompanying drawings. It is to be understood that other embodiments may be utilized, and structural and functional changes may be made without departing from the respective scope of the present disclosure. Moreover, features of the various embodiments may be combined or altered without departing from the scope of the present disclosure. As such, the following description is presented by way of illustration only and should not limit in any way the various alternatives and modifications that may be made to the illustrated embodiments and still be within the spirit and scope of the present disclosure.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggests otherwise.

Furthermore, as herein disclosed, the terms “substantially,” “about,” and variations thereof are intended to note that the described features are equal or approximately equal to a value or characteristic, as desired, reflecting tolerances, conversion factors, rounding off, measurement error and the like, and other factors. For example, the terms “substantially,” “about,” and variations thereof can denote values or characteristics that are exact or within 15% of exact, for example within 10% of exact, or within 5% of exact.

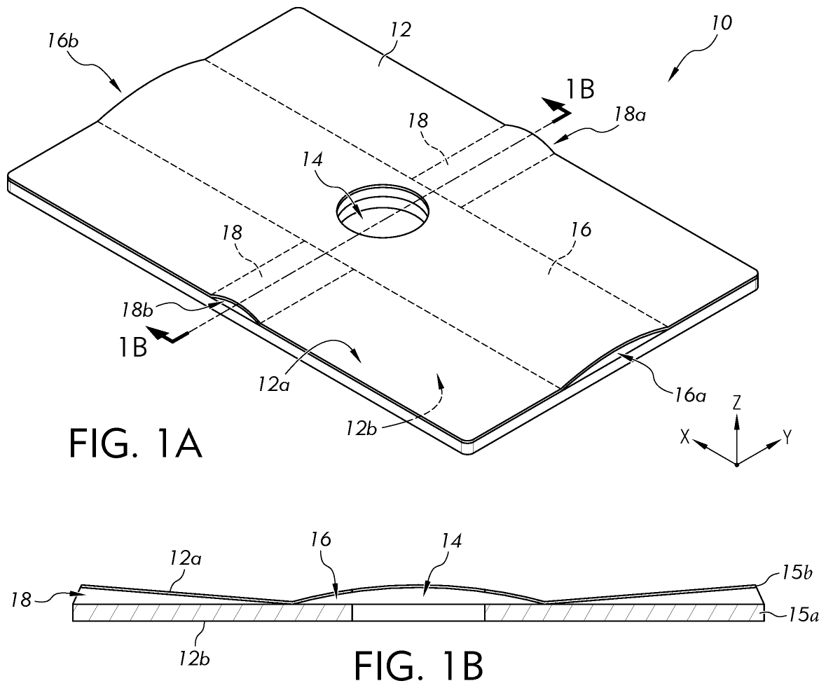

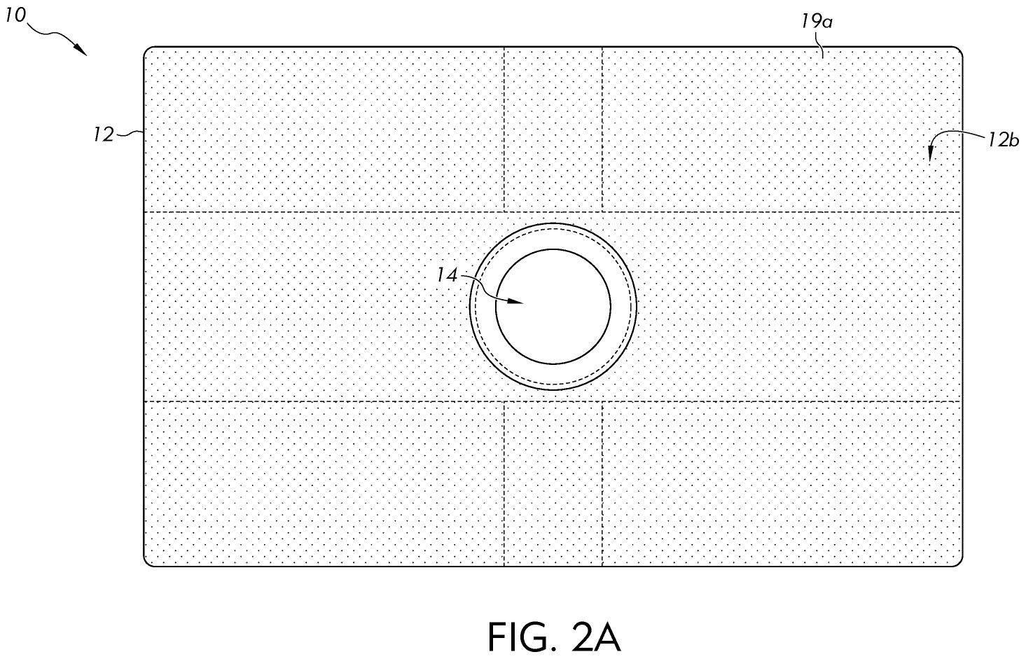

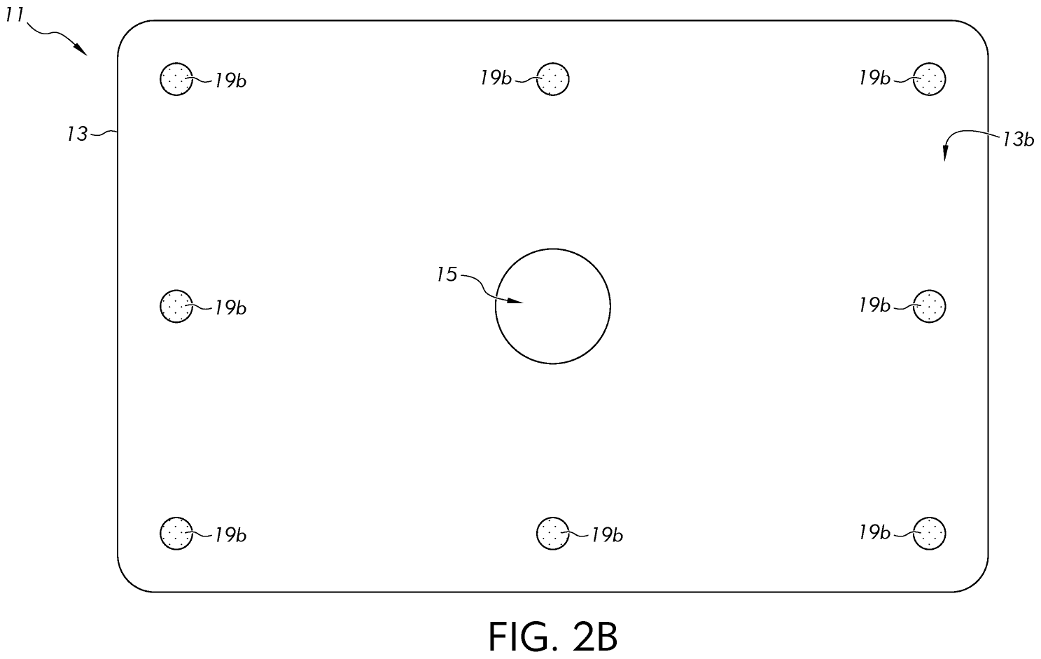

The present disclosure generally relates to a support accessory for supporting adult toys in a convenient and hands-free manner when engaging in a variety of sexual activities. Referring to FIGS. 1A-2A, a support 10, according to a first embodiment, may include a body 12 comprising an upper surface 12a and a lower surface 12b. In the illustrated embodiment, the body 12 embodies a pad that is a substantially rectangular body. It is contemplated that the body 12 may take on other shapes and forms, for example, a square, triangular, or a hexagonal-shaped body. The body 12 may comprise a thickness (measured in a direction parallel with a height axis z) that is between about 2 mm and 20 mm, from about 5 mm to about 10 mm, or about 7 mm.

In some embodiments, the body 12 may comprise a first layer 15a (FIG. 1B) of a cushioning material, for example, a foam made of polyester, PVC, TPE, polyethylene, or polyurethane (e.g., a high-density polyurethane). It is contemplated that the first layer 15a may comprise other materials, for example, rubber (e.g., nitrile butadiene rubber, etc.) or silicone. The body 12 may also include a second layer 15b (FIG. 1B) comprising a textile material giving the second layer 15b the ability to expand and contract. For example, the textile material may comprise lycra fabric, spandex, rubber, latex, elastic cotton, or other suitable elastic textile materials.

An opening 14 may extend through the first layer 15a and the second layer 15b between the upper surface 12a and the lower surface 12b. The opening 14 may be dimensioned to receive and support a variety of adult toys therefrom, as described in detail below. In the illustrated embodiment, there is one opening 14 at a center of the body. It is contemplated that there may be more than one opening extending through the body 12 and/or that the opening may be formed into other locations of the body 12.

The first layer 15a and the second layer 15b define a longitudinal channel 16 between the upper surface 12a and the lower surface 12b that extends in a direction substantially parallel with the longitudinal axis x of the body 12. In the illustrated embodiment, the channel 16 extends along an entire longitudinal length of the body 12. It is contemplated that the channel 16 may only extend about a partial length of the body 12. The channel 16 may be dimensioned to receive and support a variety of adult toys therefrom, as described below. In the embodiment shown, the channel 16 is a pass-through channel that opens to the outside via openings 16a, 16b at opposing ends of the body 12 thereof. It is contemplated that the channel 16 may be closed at one of the opposing ends thereof. It is also contemplated that the body 12 may define more than one channel 16 and/or be skewed or curved relative to the longitudinal and height axes x and z of the body 12.

The first layer 15a and the second layer 15b may also define one or more transverse channels 18 extending in a direction substantially parallel with the transverse axis y of the body 12. In the embodiment shown, there are two channels 18, and each channel 18 is closed at a respective end thereof adjacent to the opening 14, e.g., to define a pocket. It is contemplated that one or more of the channels 18 may be open at opposing ends thereof. Moreover, it is contemplated that some or all of the channels 18 may extend in a skewed or curved direction relative to the axes x, y, and z of the body 12.

Turning to FIG. 2A, the lower surface 12b of the body 12 may include a fastener 19a configured to removably attach and secure the support 10 (and an adult toy supported thereby) to a mating support structure, as described below. In the illustrated example, the fastener 19a comprises a plurality of hook and loop fasteners (i.e. VELCRO) disposed about an expansive portion (i.e., greater than 50%) of the lower surface 12b. It is contemplated that body 12 may comprise fewer hook and loop fasteners, e.g., disposed on less than 50% of the lower surface 12b thereof. It is also contemplated that the fastener may take on a variety of other forms, for example, snap-fasteners, magnets, buttons, grommets, adhesive, retainer clips, high-friction material (e.g., rubber or silicone) or openings configured to engage with mating fasteners (e.g., snap-fasteners, magnets, buttons, grommets, retainer clips, a high-friction material, etc.) disposed about the surface (i.e., an attachment surface) of a mating support structure.

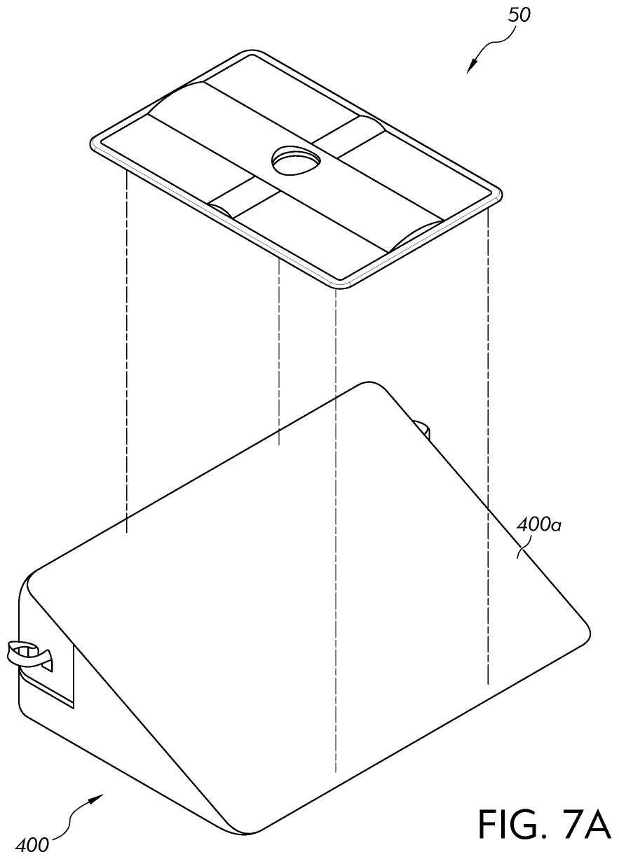

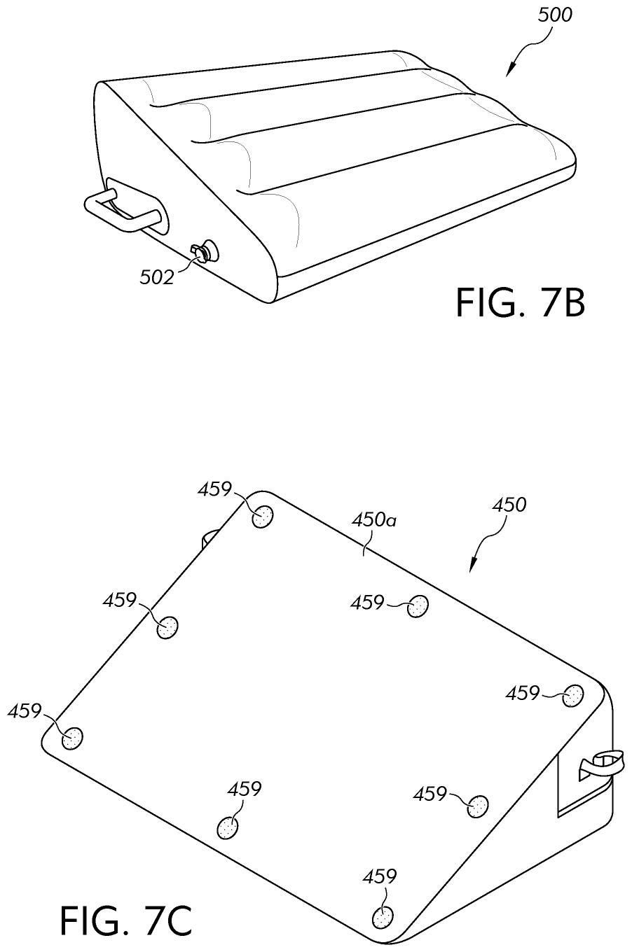

For example, referring to FIG. 2B, a support 11 according to another embodiment may include a body 13 with a plurality of fasteners 19b (e.g., snap-fasteners, magnets, buttons, grommets, retainer clips, openings, and the like) arranged about the lower surface 13b thereof. In this embodiment, the fasteners 19b are configured to align and engage with mating fasteners 459 (FIG. 7C) disposed on an upper surface 450a of a mating structure (FIG. 7C). The mating fasteners may include, for example, snap-fasteners, magnets, buttons, grommets, retainer clips, and the like) disposed on an upper surface 450a of the mating structure 450.

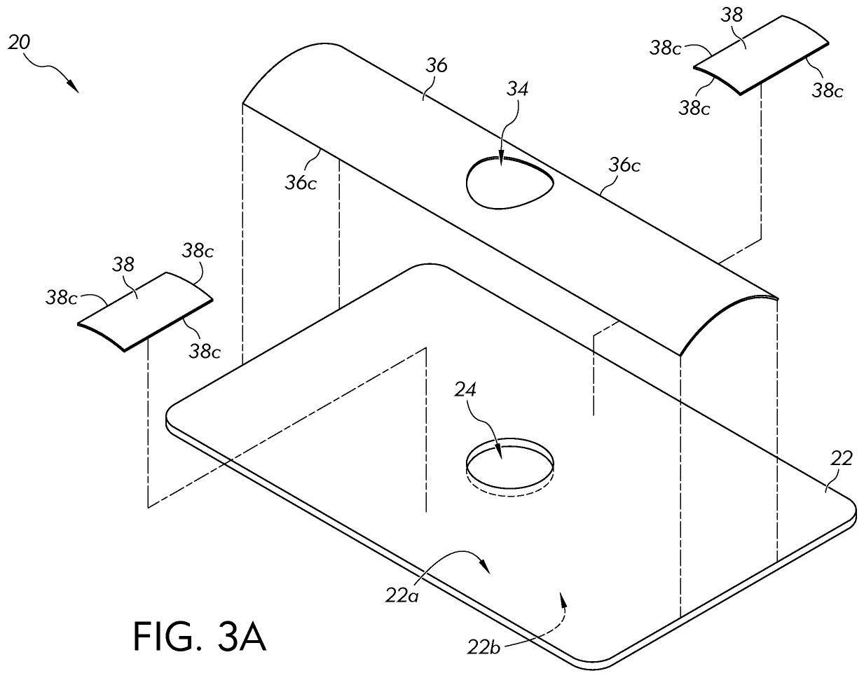

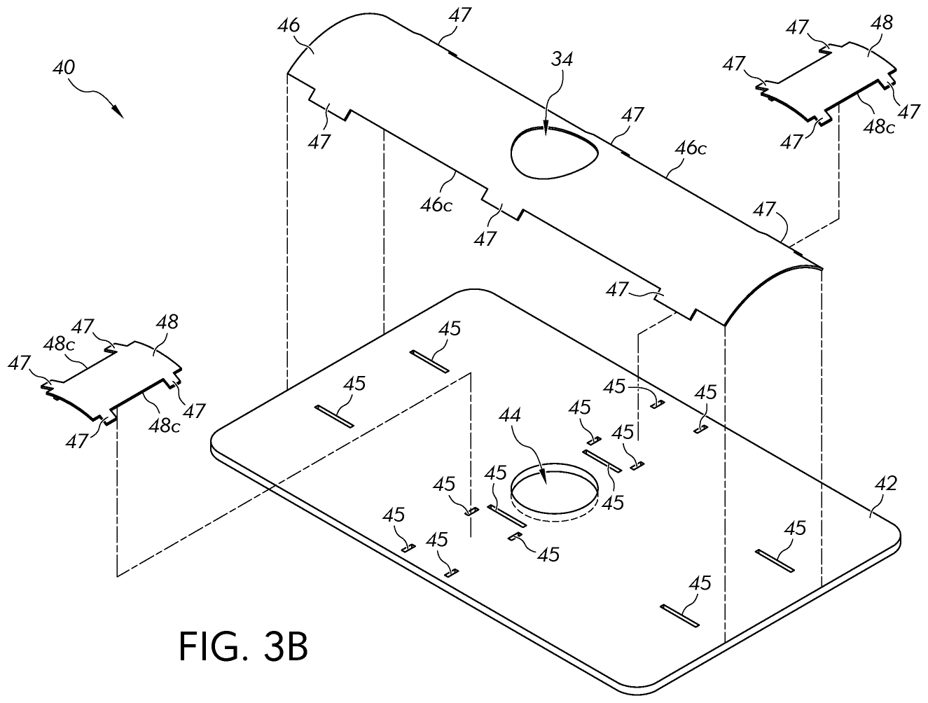

Turning now to FIG. 3A, an exploded view of an example support 20 according to another embodiment is shown. The support 20 includes similar features to supports 10, 11. Accordingly, a description of similar features has been omitted for brevity, except for the differences noted below.

In this embodiment, the support 20 includes a body 22 comprising a plurality of strips 36, 38 that are attached to the upper surface 22a of the body 22. In some embodiments, the strips 36, 38 comprise a textile material, for example, a stretch fabric/elastic material giving the strips 36, 38 the ability to expand and contract. For example, the textile material may comprise lycra fabric, spandex, rubber, latex, elastic cotton, or other suitable elastic textile materials. The plurality of strips 36, 38 may be attached to the upper surface 22a of the body 20 in a variety of ways, for example, by knitting, weaving, bonding, sewing, ultrasonic welding, or adhering the respective edges 36c, 38c thereof to the upper surface 22a such that when attached thereto, the strips 36, 38 define the respective channels (e.g., 16 and 18 in FIG. 1A) of the support 20. In such embodiments, the upper surface 22a may comprise a suitable textile material (e.g., a fabric) to facilitate attaching (e.g., sewing or knitting) the strips 36, 38 thereto. In the embodiment shown, strip 36 may define an opening 34 extending therethrough dimensioned to correspond with opening 24 of the body 22.

Turning to FIG. 3B, another example support 40 is shown. The support 40 includes similar features to supports 10, 11, 20. Thus, a detailed description of similar features has been omitted, except for the following differences. In this embodiment, the body 42 of the support 40 may define a plurality of fasteners 45 for removably attaching strips 46 and 48 thereto. In this embodiment, the fasteners 45 may embody snap-fasteners, magnets, buttons, grommets, retainer clips, or openings dimensioned and aligned to engage with mating fasteners 47 (e.g., snap-fasteners, magnets, buttons, grommets, retainer clips, and the like) disposed about edges 46c, 48c, of the strips 46, 48. In this manner, the strips 46, 48 may be attached to the body 42 and removed when it is desired to clean the strips 46, 48 and/or the body 42. In some embodiments, the body 42 may comprise a cushioning material (e.g., foam), a rigid material (e.g., plastic), or a suitable textile material (e.g., a nylon fabric), and the strips 46 and 48 may comprise a textile material, for example, any suitable example of a textile material disclosed herein.

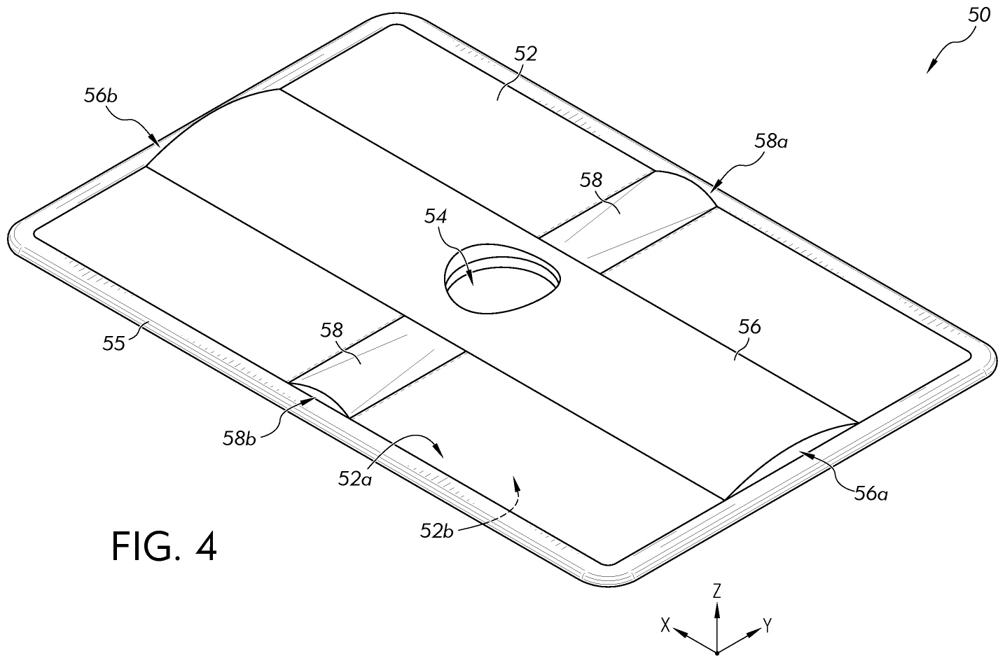

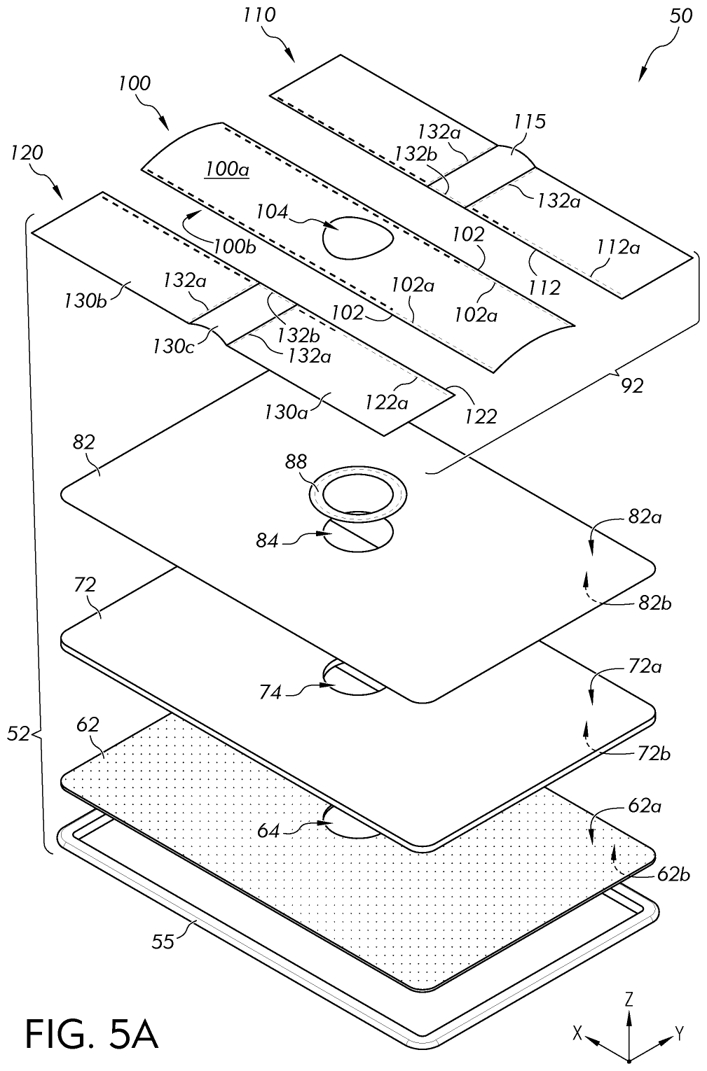

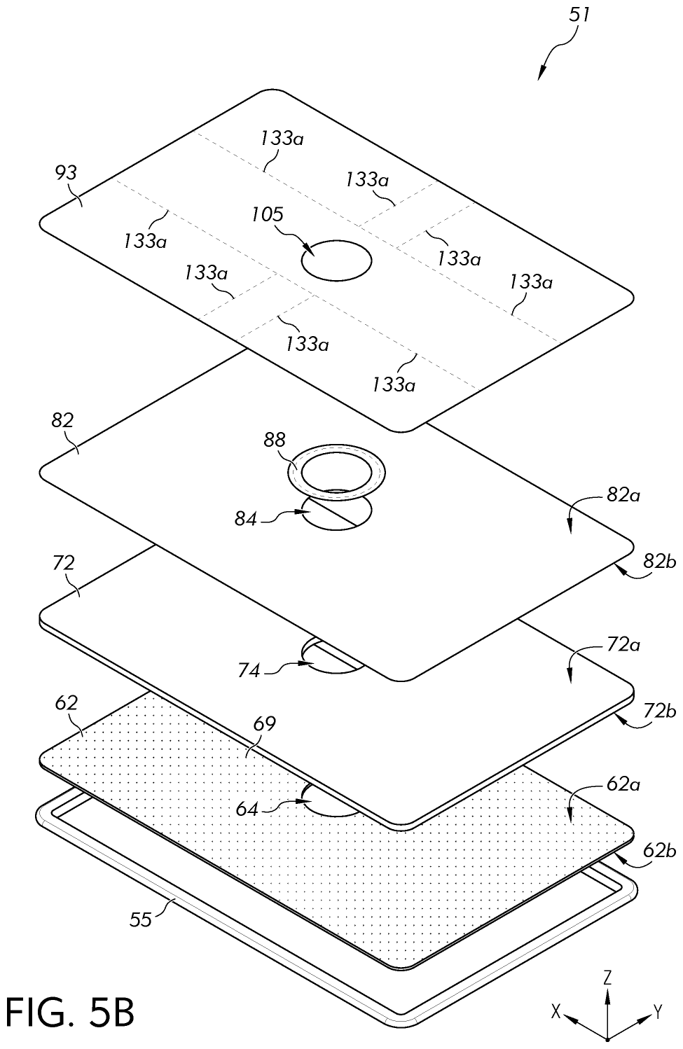

Turning now to FIGS. 4-5B, another example support 50 is shown. The support 50 includes similar features as supports 10, 11, 20, and 40 discussed above. Thus, a description of similar features has been omitted, except for the following differences. In this embodiment, the support 50 includes a body 52 comprising a plurality of stacked layers (FIG. 5A). The plurality of layers may include some or all of a first layer 62 (i.e., a lower layer), a second layer 72, a third layer 82, and a fourth layer 92 (i.e., an upper layer).

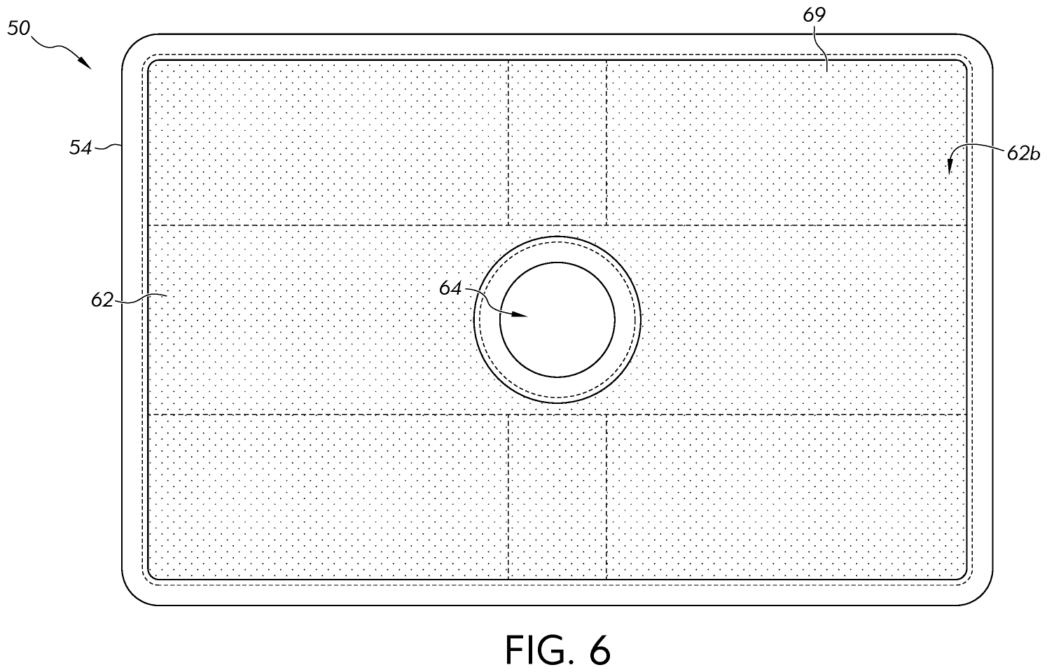

The first layer 62 includes an upper surface 62a and a lower surface 62b with an opening 64 extending therebetween. The first layer 62 may be joined to some or all of the second layer 72, the third layer 82, and the fourth layer 92 via a textile binding 55. It is also contemplated that the first layer 62 may be adhered, bonded, sewn, laminated, or knitted to the second layer 72. The lower surface 62b (FIG. 6) may comprise a fastener 69 (FIG. 6) configured to engage a mating fastener on a mating support structure (e.g., 400 in FIG. 7A) to removably attach the support 50 to the mating support structure, as described below. The fastener 69 may take on any suitable form, for instance, any suitable example of a fastener described herein. In some embodiments, the fastener may be disposed about a lower surface 72b of the second layer 72, for instance, in embodiments that do not include a first layer 72.

The second layer 72 includes an upper surface 72a and a lower surface 72b spaced apart by a thickness (as measured along the height axis z) that is, for example, between about 1 mm and 5 mm, between about 2 mm and 4 mm, or about 3 mm. An opening 74 may extend between the upper surface 72a and the lower surface 72b. The opening 74 may be aligned with the opening 64 of the first layer 62. The second layer 72 may comprise a variety of different cushioning materials, for example, an ethylene-vinyl acetate foam, a polyethylene foam, a polyester foam, a polyurethane foam, a rubber (e.g., a Styrene Butadiene Rubber), and/or any other suitable example of a cushioning material disclosed herein. In some embodiments, an upper surface 72a of the second layer 72 may be adhered or bonded to a lower surface 82b of the third layer 82. It is also contemplated that the second layer 72 may be knitted, sewn, woven, joined, or welded (e.g., ultrasonic welded) to the third layer 82.

Referring to FIG. 5A, the third layer 82 includes an upper surface 82a and a lower surface 82b with an opening 84 extending therebetween. The opening 84 is aligned with the openings 64, 74 of the first and second layers 62, 72, respectively. The third layer 82 may comprise a textile material, for example, a nylon fabric (e.g., a nylon knit loop), a felt made of natural or synthetic fibers, or any other suitable example of a textile material disclosed herein. In some embodiments, the third layer 82 may comprise the second layer 72, for example, in such embodiments wherein the second layer 72 is integrated (e.g., laminated, bonded) to the third layer 82 to form a single layer. In some embodiments, an annular binding 88 may be disposed about a periphery of the opening 84 and attached (e.g., sewn) thereto to secure the third layer 82 to one or both of the first layer 62 and the second layer 72.

The fourth layer 92 may comprise one or more strips of textile material (e.g., lycra fabric, spandex, rubber, latex, elastic cotton, or other suitable examples) partly defining channels 56, 58 (FIG. 4) when attached to the third layer 82. In such embodiments, the fourth layer may comprise a material with a soft, supple texture (e.g., lycra fabric) that is smooth to a user's skin. In the illustrated embodiment, the fourth layer 92 comprises a first strip 100 disposed between second and third strips 110, 120. The first strip 100 includes an upper surface 100a and a lower surface 100b, with an opening 104 extending therebetween. The opening 104 is aligned with openings 64, 74, and 84 of the first, second, and third layers 62, 72 and 82, respectively.

The first strip 100 extends longitudinally and may be attached to the second and third strips 110, 120 by joining opposing sides 102 of the first strip 100 to respective, adjacent sides 112, 122 of the second and third strips 110, 120. In some embodiments, this may be done by disposing the opposing sides 102 of the first strip 110 about the adjacent sides 112, 122 such that the opposing sides 102 at least partially overlap with the adjacent sides 112, 112. In this manner, the sides 102, 112, 122 may then be joined (e.g., stitched) together about attachment lines (e.g., stitch lines) 102a, 112a, and 122a extending in a longitudinal direction between opposing ends of the strips. In other embodiments, the respective sides 102, 112, 122 may be joined together using other forms of attachment, for example, by bonding or welding (e.g., ultrasonic welding) the respective sides 102, 112, 122 to each other along the attachment lines 102a, 112a, and 122a. In the embodiment shown, opposing edges of the first strip 100 (extending in a direction parallel to the transverse axis y) are not attached (e.g., sewn) to the first through third layers thereunder (via the textile binding 55) such that the opposing edges define openings 56a, 56b (FIG. 4) to the channel 56 extending therebetween.

Referring now to FIG. 5A, a description of the third strip 120 will be described. In the illustrated embodiment, the third strip 120 and the second strip 110 comprise identical features. Accordingly, it should be understood that the following description also applies to the second strip 110. The third strip 120 may comprise a first portion 130a, a second portion 130b, and a third portion 130c therebetween. In some embodiments, the first, second, and third portions 130a, 130b, and 130c may comprise separate structural elements that are joined together along attachment lines 132a, e.g., by being sewn, bonded, or welded to each other via ultrasonic welding. In other embodiments, the first, second, and third portions 130a, 130b, and 130c may integrally form part of a single structural element.

In the embodiment shown, the third strip 120 is joined to the third layer 82 along attachment lines 132a extending parallel relative to the transverse axis y, and along attachment lines 132b extending parallel relative to the longitudinal axis x. In some embodiments, the attachment lines 132a, 132b may embody stitch lines, for example, to attach the third strip 120 to the third layer 82 via sewing along the stitch lines. Although it should be appreciated that third strip 120 may be attached to the third layer 82 using other forms, for example, by bonding or welding (e.g., ultrasonic welding) the third strip 120 to the third layer 82 along the attachment lines 132a, 132b. In some embodiments, the method of attachment may include sewing, bonding, or welding (e.g., ultrasonic welding) the third strip 120 to some or all of the third layer 82, the second layer 72, and the first layer 62 along the attachment lines 132a, 132b. In any of the foregoing examples, the attachment lines 132a, 132b may demarcate channels 58 (FIG. 4). Moreover, the third strip 120 may be attached to the third layer 82 via the textile binding 55, except along edges of the second portion 130c that at least partly define the openings 58a, 58b to the channels 58.

Turning now to FIG. 5B, a support 51 according to another embodiment will now be described. The support 51 shares similar features to support 50 of FIG. 5A. Accordingly, a description of similar features has been omitted for brevity, except for the following differences. In this embodiment, the support 51 may include a fourth or upper layer 93 comprising a single layer or sheet of textile material (e.g., lycra fabric, spandex, rubber, latex, elastic cotton, or other suitable examples) that is joined to the third layer 82 about attachment lines 133a, for example, by sewing, stitching, bonding, or welding (e.g., ultrasonic welding) the upper layer 93 to the third layer 82 along the attachment lines 113a, such that when attached thereto, the upper layer 93 and the third layer 82 define channels (e.g., 56, 58 in FIG. 4) demarcated by the attachment lines 133a.

An example use of support 50 will now be described referring to FIGS. 7A-13. It should be understood that the following description similarly applies to supports 10, 11, 20, 40, and 51 discussed above.

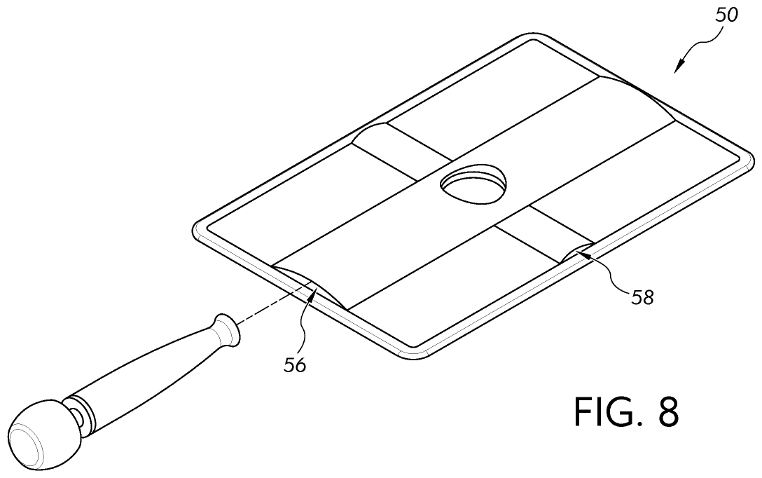

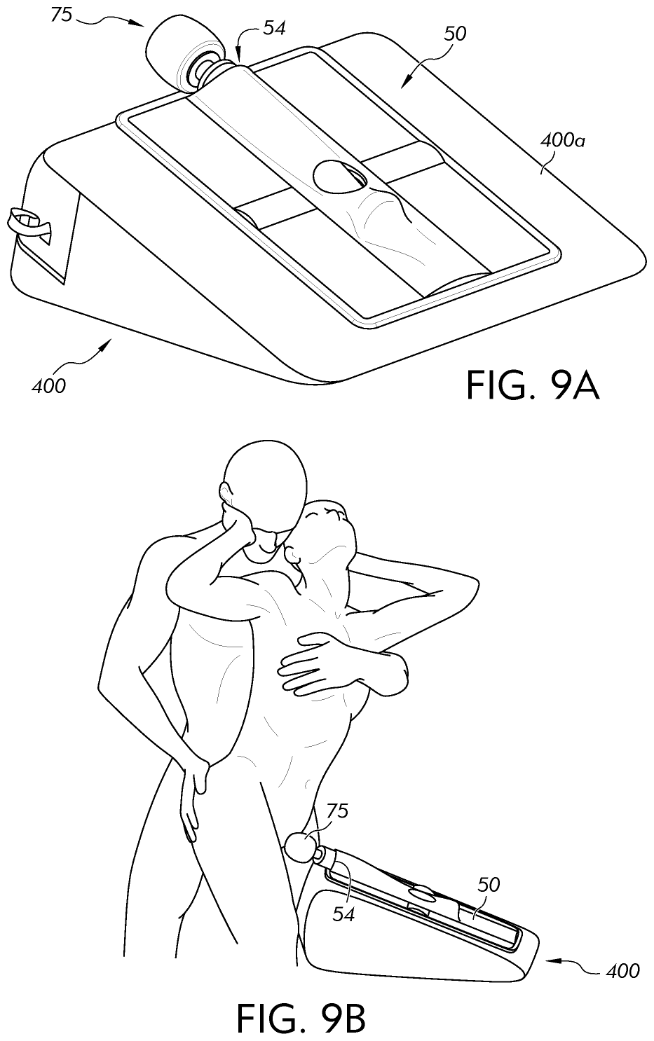

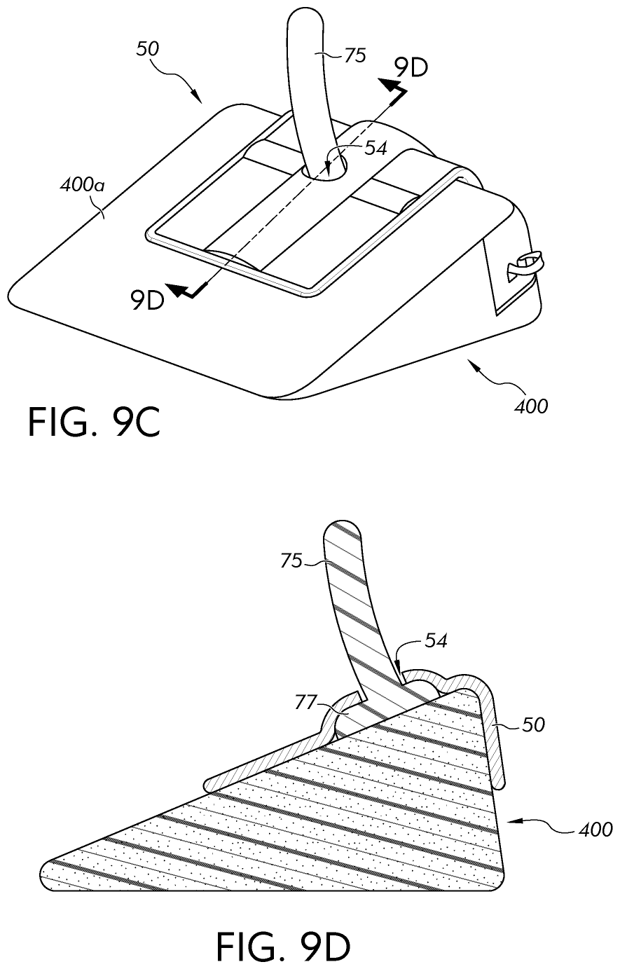

In some embodiments (FIG. 7A), the support 50 may be used in conjunction with a positioner 400 (i.e., a mating support structure) configured to elevate an adult toy such that it is in proximity to a person's genitals, e.g., elevated via the positioner. For this purpose, the positioner 400 may include an upper surface 400a comprising a mating fastener (e.g., a hook & loop fabric, nylon face fabric, or any other suitable disclosed herein) configured to engage the fastener 69 (FIG. 6) disposed on a lower surface of the support 50. When attached thereto, the support 50 may be used to receive and position an adult toy (e.g., 75 in FIG. 9A) such that an operable or engaging end of the adult toy in proximity to a person's genitals, for example, as shown in FIG. 9B.

In some embodiments, the positioner 400 may comprise a cushioning material, for example, a foam core. In other embodiments, referring to FIG. 7B, the positioner may take the form of an inflatable positioner 500 with an air inlet valve 502, permitting the user to easily stow the positioner away when not in use, e.g., in a suitcase while on travel, etc. As noted above, the positioner may take on other forms. For instance, referring to FIG. 7C, a positioner 450 may comprise an upper surface with mating fasteners 459 thereon configured to engage with fasteners (e.g., 19b in FIG. 2B) disposed on a lower surface of a support. It is also contemplated that the positioner may comprise different shapes and forms. For example, the positioner may be dimensioned (e.g., elongated) such that it may receive a plurality of supports thereon in a side-by-side manner, for example, when multiple people are concurrently engaging in a sexual activity. In some embodiments, the positioner may comprise a rectangular shape, e.g., instead of a wedge-like shape with an inclined surface as shown. In some embodiments, the positioner may embody a sex doll (e.g., depicting a man or a woman) with a mating fastener thereon for attaching the support (with an adult toy) thereto.

When attached to the positioner 400, the support 50 (FIG. 8) may be used to receive at least a portion of an adult toy therein. Because the fourth or upper layer 92 of the support may comprise an elastic material (e.g., a stretch fabric, spandex, etc.), the support 50 may be used with adult toys comprising varying cross-sectional dimensions that are greater than the cross-sectional dimension of the channels 56, 58 (FIG. 4) in a contracted state. For instance, introducing one or more adult toys into the channels 56, 58 will cause the channels 56, 58 to expand and contract about the adult toy (e.g., 75 in FIG. 9A) to secure the adult toy to the support. The contraction of the upper layer 92 (due to the elasticity thereof) is particularly beneficial to inhibit the adult toy from unintentionally moving out of the channel, for example, based on vibration (e.g., of the adult toy) or physical movement of the person being stimulated that otherwise may cause the adult toy to fall or slip out.

As shown in FIGS. 8 and 9A, an adult toy 75 comprising an elongated object (e.g., a vibrator) may be introduced into channel 56, by extending the adult toy 75 into the channel 56 (FIG. 4) via one of the channel openings, whereupon the upper layer will contract around the adult toy via the elasticity thereof. In this manner, the support 50 with the adult toy 75 may then be attached to the positioner (as shown in FIGS. 9A and 9B) in proximity to a receiving person's genitals, for example, to further stimulate the receiving person during intercourse with a penetrating person in a manner that is hands free. It is also contemplated that the support 50 may be attached to the positioner before introducing the adult toy 75 into the channel 56.

While the embodiment of FIG. 9B shows a penetrating person and a receiving person, it should be understood that the support 50 may be used with one person, for example, a person desiring to stimulate them self.

As shown in FIGS. 9C and 9D a user may desire to position an adult toy 75 (e.g., an elongated object mimicking a penis) such that it protrudes upward and through the opening 54 of the support 50, for example, to pleasure them self by squatting down onto the adult toy to insert the adult toy into their genitals or anus. In this example, the adult toy 75 may be positioned such that a flare or base 77 (FIG. 9D) thereof is sandwiched in between the support 50 and the positioner 400, thereby securing the adult toy 75 in an upright configuration.

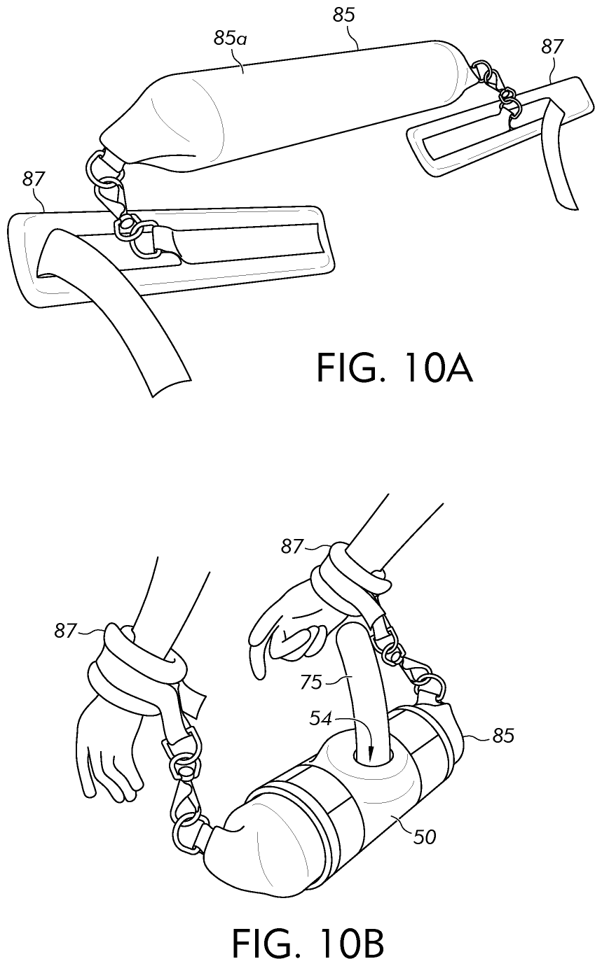

In the foregoing embodiments, the support 50 may comprise one or more layers of flexible material (e.g., fabric, foam, rubber, latex, spandex, cotton, etc.) enabling the support 50 to be flexed. This aspect of the present disclosure enables the support to be attached to support structures comprising non-planar surfaces. For example, referring to FIGS. 10A and 10B, a user may desire to utilize the support 50 on contoured objects, including, but not limited to, a padded, elongated bar 85 (e.g., comprising a foam core). In this example, the base 77 (FIG. 9D) of the adult toy 75 may be sandwiched between an outer, contoured surface 85a (FIG. 10A) of the padded bar 85 and the support 50, for example, when the support 50 is flexed to wrap around the padded bar 85 to secure the adult 75 therefrom. It is contemplated that user may manipulate the adult toy via the handcuffs 87 (strapped to their arms) to bring the adult toy 75 into engagement with the user's genitals or anus.

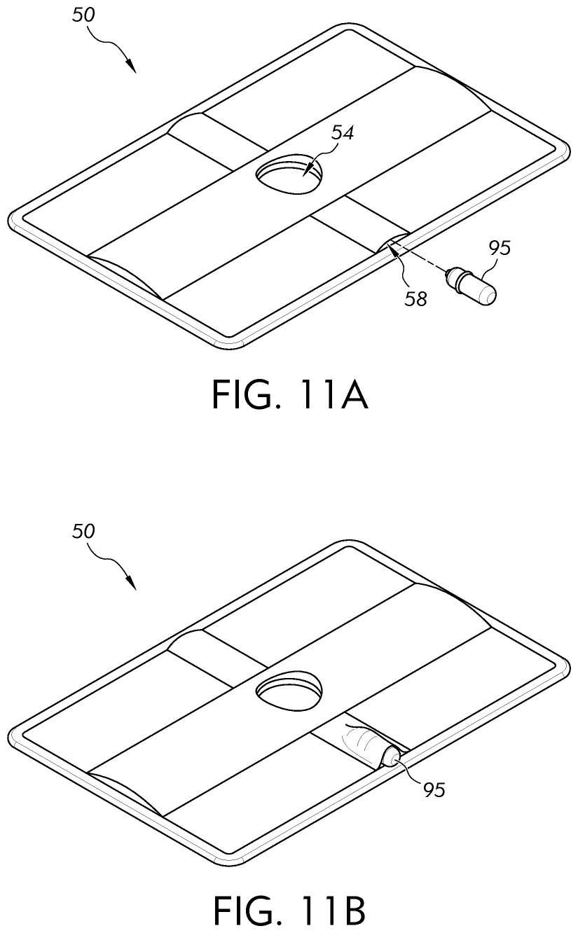

In some embodiments, a user may desire to attach more than one adult toy to the support. For instance, referring to FIGS. 11A and 11B, a user may utilize the support to accommodate one or more small adult toys 95 (e.g., small vibrators) in the pockets defined by channels 58 (FIG. 4), and then another adult toy 75 (FIG. 9C) through the opening 54, for example, when it is desired to stimulate multiple people or areas of a person's body concurrently. In this manner, it should be understood that the various examples of supports disclosed herein are versatile, insofar as they enable one or more persons to engage in a wide variety of sexual activities (and positions), in a convenient and hands-free manner.

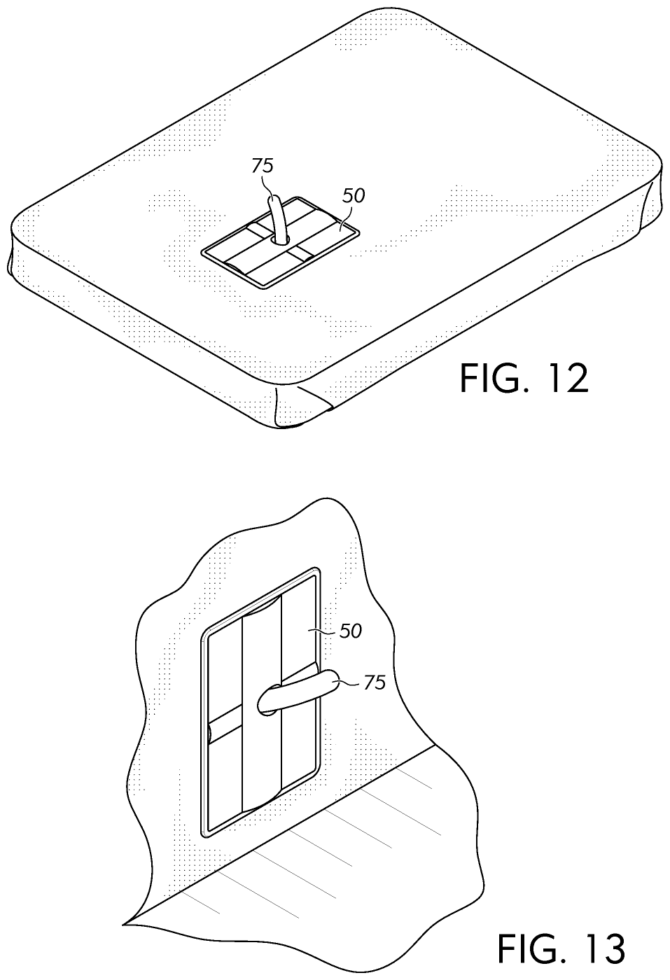

Referring to FIGS. 12 and 13, in some embodiments, a user may desire to attach the support 50 to other examples of support structure comprising a mating fastener (e.g., a hook and loop compatible fabric). For example, as shown in FIG. 12, the support 50 may be removably attached to an upper surface of a bed to position and secure an adult toy (relative to the bed) in a manner that constrains the adult toy from being moved, e.g., during intercourse or foreplay. In some embodiments, the support 50 may be brought into engagement with a support structure comprising a wall (FIG. 13) including a mating fastener (e.g., a hook and loop compatible fabric to) to extend an adult toy outwardly therefrom for engagement with a person's genitals. In some embodiments, a plurality of supports 50 may be attached to a bed, a wall, or multiple positioners, for example, when a group of individuals desire to concurrently participate in a group sexual act.

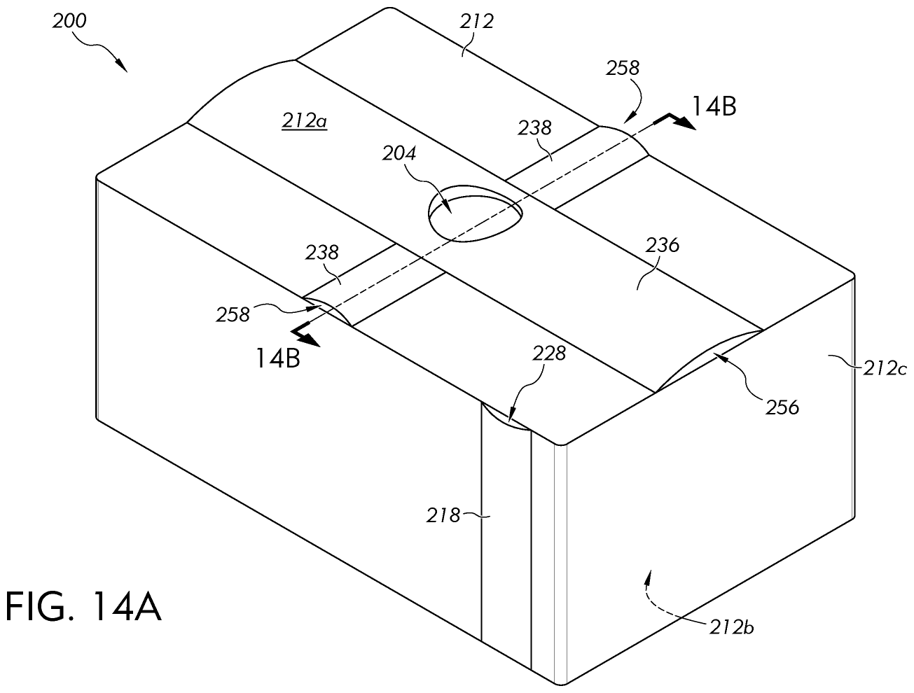

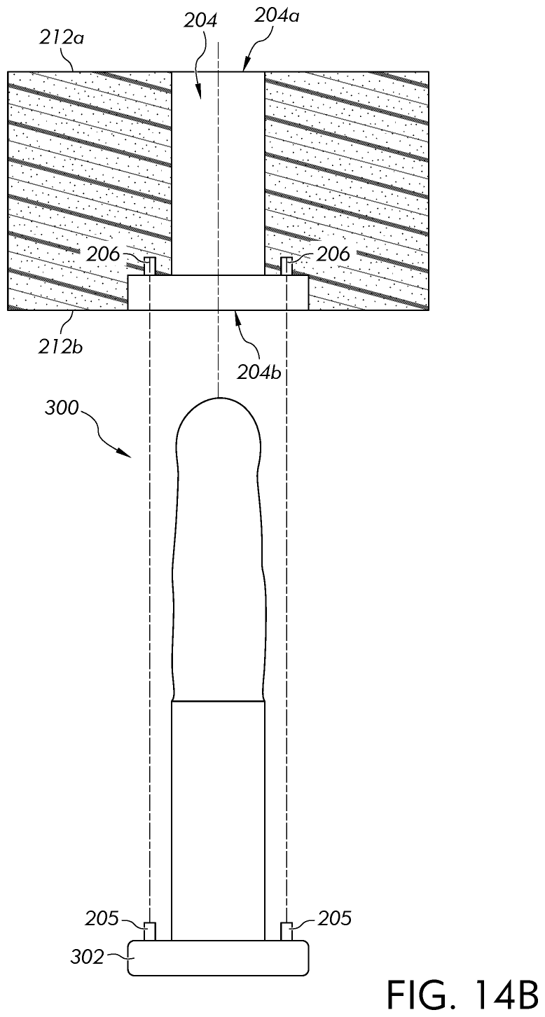

Although the previous embodiments depict a support in the form of a planar pad, it should be understood that other examples of supports are within the scope of the present disclosure. For example, turning now to FIGS. 14A and 14B, an example support 200 according to another embodiment may comprise a body 212 including an upper surface 212a and a lower surface 212b spaced apart and connected by a side wall 212c extending between. The body 212 may comprise a foam core (e.g., for example, any suitable example of a foam disclosed herein). In this embodiment, the body 212 embodies a positioner (e.g., a mating support structure) configured to elevate the support 200 relative to a support surface, for example, when the lower surface 212b of the body 212 rests on the support surface. In other embodiments, the body 212 may embody an inflatable element with a valve, permitting the user to stow the support away when not in use, e.g., during travel.

A passage 204 opens to the upper surface 212a at a first opening 204a, and to the lower surface 212b at a second opening 204b. In some embodiments, the passage 204 may be counterbored (FIG. 14B) proximate the lower surface 212b and dimensioned to engage with a flare or base 302 of an adult toy 300. In some embodiments, the second opening 204b may comprise a protrusion or opening 206 configured to engage with a mating opening or protrusion 205 formed on an adult toy 300 to secure the adult toy 300 in place. In some embodiments, the support 200 may comprise a plurality of passages (e.g., like 204) located within the body 212 to receive and support a plurality of adult toys.

In some embodiments, a plurality of strips 236, 238 of textile material may be attached to the upper surface 212a, each defining a respective channel 256, 258 when attached thereto for receiving an adult toy. In some embodiments, one or more strips 218 may also be attached to one of the side walls 212c of the support 200 to define additional channels for receiving adult toys, e.g., in a vertical, upright orientation.

In some embodiments, it is contemplated that the various examples of supports 10, 11, 20, 40, 50, and 51 and support structures (e.g., positioners, positioner bar, bed, wall, sex doll) may be made available as a kit. It is also contemplated that various adult toys may be made available with the kit, and be shaped and dimensioned to provide for a snug fit when received by the channels or openings of the support.

Although the embodiments of the present invention have been illustrated in the accompanying drawings and described in the foregoing detailed description, it is to be understood that the present disclosure is not to be limited to just the embodiments disclosed, but that the disclosure described herein is capable of numerous rearrangements, modifications and substitutions without departing from the scope of the claims hereafter. The terms “includes,” “including,” and “include” are inclusive and have the same scope as “comprises,” “comprising,” and “comprise” respectively. The claims as follows are intended to include all modifications and alterations insofar as they come within the scope of the claims or the equivalent thereof.

1. A support for adult toys comprises:
a body including an upper surface and a lower surface, wherein the body defines an opening extending between the upper surface and the lower surface, wherein the opening is dimensioned to receive a portion of an adult toy therethrough, wherein the support is configured to be removably attached to a support structure to secure the adult toy to the support structure.

2. The support of claim 1, wherein the body defines a channel extending in a direction substantially perpendicular to the opening, wherein the channel is configured to receive a second adult toy therein.

3. The support of claim 2, wherein the body comprises an upper layer defining the upper surface, and a wherein the upper layer is configured to expand to enlarge the channel when inserting the second adult toy therein.

4. The support of claim 1, wherein a fastener is attached to the lower surface of the body, wherein the fastener is configured to removably attach the support to a mating fastener disposed on the support structure.

5. The support of claim 4, wherein the fastener and the mating fastener each comprise a hook and loop fastener.

6. The support of claim 1, wherein the body comprises an upper layer and a lower layer, wherein the body defines a first channel extending between the upper layer and the lower layer.

7. The support of claim 6, wherein the body defines a second channel extending between the upper layer and the lower layer, wherein the second channel is closed at an end thereof to define a pocket for a third adult toy.

8. The support of claim 1, wherein the body comprises a flexible material enabling the support to flex and attach to a non-planar surface.

9. An adult toy kit, comprising:
a support comprising a flexible body, wherein the body defines an opening extending between an upper surface and a lower surface thereof dimensioned to receive an adult toy therethrough, wherein the lower surface includes a fastener thereon; and
a positioner comprising an outer surface with a mating fastener disposed thereon configured to engage with the fastener of the support to removably attach and secure the support to the positioner.

10. The adult toy kit of claim 9, wherein the kit further comprises the adult toy, wherein the adult toy comprises a base that is sandwiched between the support and the positioner to secure the adult toy to the positioner.

11. A support comprises:
a body including a first layer and a second layer, wherein the first layer and the second layer define a first channel therebetween extending in a direction substantially parallel to an upper surface of the first layer, wherein the channel is configured to receive a portion of an adult toy therein.

12. The support of claim 11, wherein the first layer is configured to expand and contract, and wherein the second layer comprises a fastener on a lower surface thereof configured to engage with a mating fastener on a positioner to removably attach and secure the support to the positioner.

13. The support of claim 11, wherein the first layer and the second layer define an opening extending between an upper surface of the first layer and a lower surface of the second layer, wherein the opening is configured to receive a portion of a second adult toy therethrough.

14. The support of claim 12, wherein the fastener and the mating fastener comprise at least one of: a magnet, a hook and loop fastener, a snap-fastener, a grommet, an adhesive, a clip, a rubber material, a silicone material, and an opening.

15. The support of claim 11, wherein the first layer and the second layer further define a second channel therebetween extending in a direction substantially perpendicular to the first channel, wherein the second channel is configured to receive a portion of a second adult toy therein.

16. The support of claim 11, wherein the second channel is closed at an end thereof to define a pocket for accommodating at least a portion of a third adult toy therein.

17. The support of claim 11, wherein the first layer comprises a plurality of strips attached to the second layer, wherein the plurality of strips are attached to the second layer along attachment lines.

18. The support of claim 17, wherein the plurality of strips are attached to the second layer via ultrasonic welding, stitching, or bonding along the attachment lines.

19. The support of claim 18, wherein the attachment lines demarcate the first channel between the first layer and the second layer.

20. The support of claim 19, wherein the first channel extends between opposing ends of the body.
